(19) United States
(12) Patent Application Publication
(10) Pub. No.: US 2023/0279721 A1
(43) Pub. Date: Sep. 7, 2023

(54) SYSTEM FOR DETERMINING A QUALITY OF THE THERMAL INSULATION OF AN INSULATING GLAZING IN A BUILDING

(71) Applicant: SAINT-GOBAIN GLASS FRANCE, COURBEVOIE (FR)

(72) Inventors: Christian EFFERTZ, AACHEN (DE); Volkmar OFFERMANN, ESCHWEILER (DE); Alicia DRÖGE, HERZOGENRATH (DE); Andreas BITTIS, AACHEN (DE)

(21) Appl. No.: 18/008,342

(22) PCT Filed: Jul. 12, 2021
(86) PCT No.: PCT/EP2021/069258

§ 371 Date: Dec. 5, 2022

(30) Foreign Application Priority Data
Jul. 21, 2020 (EP) 20186852.8

(51) Int. Cl. E06B 3/677; E06B 3/66

(52) U.S. Cl. CPC E06B 3/677; E06B 3/6612

(57) ABSTRACT

A system for determining a quality of the thermal insulation of an insulating glazing in a building having an insulating glazing, the system including a sensor system having at least one sensor unit, wherein the sensor unit is provided for measuring at least one measurement value and the sensor system is provided for detecting a time profile of the thermal insulation properties of the insulating glazing, and a system for forwarding data generated by the sensor system to a terminal, and wherein the sensor unit has a computing unit for generating data, a communication unit for the wireless exchange of data, and an energy supply unit; and the measurement value indicates a physical property, in particular the thermal flow, of the insulating glazing.

The invention relates to a system for determining a quality of the thermal insulation of an insulating glazing in a building. It further relates to an insulating glazing assembly.

Insulating glazings are usually produced using prefabricated insulating glazing units that have a spacer profile extending around between two glass panes and can, optionally, also include more than two glass panes in the composite. Such insulating glazing units are used in façade glazings, windows, or doors.

For decades, insulating glazings have been an indispensable component of residential and functional buildings in the industrialized countries, especially in temperate and colder climate zones. In the course of the worldwide efforts for climate protection and for saving heating and air conditioning costs, they are becoming increasingly significant and are increasingly used.

The thermal insulation properties of insulating glazings play an important role in the energy efficiency of a building. Replacing the windows (due to production, logistics, replacement, etc.) increases the CO2 footprint of the building, which can have a negative impact on the ecological balance of the building. On the other hand, if the building is operated with windows having reduced thermal insulation properties, its ecological footprint worsens since more CO2 is used for heating or cooling. Thermal insulation capacity and costs are critical factors in the choice of the right time to replace the insulating glazing.

Consequently, there is a need for a solution for a solution that allows easy determination of a current quality of insulating glazing in a building.

An alarm pane assembly having a humidity sensor and a motion sensor is known from WO 2015/154688 A1. The alarm unit is arranged on a spacer profile of a pane assembly and includes the humidity sensor and the motion sensor. When the motion sensor detects motion, the humidity sensor compares the current humidity with a previously stored humidity and triggers an alarm if the humidity has changed.

From WO 2007/099407 A2, a system is known for determining the gas content in a closed atmosphere, which comprises a window unit with an enclosed atmosphere and an oxygen-sensitive material. The material is arranged in the enclosed atmosphere and detects an oxygen content in the atmosphere. A non-invasive sensor is provided to read out the oxygen-sensitive material in order to determine the gas content in the atmosphere.

From CA 2298806 A1, an insulating unit is known having an access for introducing a flexible electrode in a sealed insulating cavity. Also disclosed is a measuring device for measuring and displaying the concentration of the gas detected by the electrode.

It has also been proposed to provide insulating glazing units with “electronic” identifiers, in particular radio readable identifiers, so-called RFID transponders. Such insulating glazing units are disclosed, for example, in WO2007/137719 A1 and WO2019/219461 A1.

The object of the invention is to specify an uncomplicated, ecological, and economically reasonable solution for determining a quality of the thermal insulation of an insulating glazing in a building.

According to the invention, the object of the present invention is accomplished by a system in accordance with the independent claim 1. Preferred embodiments of the invention are apparent from the defendant claims.

A system according to the invention for determining a quality of the thermal insulation of an insulating glazing in a building has an insulating glazing and at least one sensor system having at least one sensor unit. The sensor unit is provided for measuring at least one measurement value. The sensor system is provided for detecting a time profile of the thermal insulation properties of the insulating glazing. Furthermore, the system includes means for forwarding data generated by means of the sensor system to a terminal, with the sensor unit having a computing unit for generating data, a communication unit for the wireless exchange of data, and an energy supply unit and the measurement value indicating a physical property, in particular the thermal flow, of the insulating glazing.

According to the invention, the system is set up to detect both a time profile of the insulating properties, for example, thermal flow, and the physical properties of the insulating glazing, for example, temperature, pressure, and humidity. These data are made available to a user immediately in an uncomplicated manner. In this way, a user of the system is informed of the quality of the thermal insulation.

In the context of the invention, the “quality” can also mean the quality of the thermal insulation in terms of physical properties, in particular the thermal flow, of the insulating glazing.

The insulating glazing can, in particular, be an insulating glazing with a first and a second pane. The first pane has a first surface (I) and a second surface (II). It is configured as an outer pane. The second pane is configured as an inner pane and has a first surface (III) and a second surface (IV). The insulating glazing has a first cavity between the first and second pane. The first and second pane are in particular glass panes. The expression “a pane configured as an inner pane” means the pane that, in an installed state, for example, in a building or vehicle, is oriented toward the interior. “A pane configured as an outer pane” means the pane that, in an installed state, is oriented away from the interior.

The sensor system is provided to detect a time profile of the thermal insulation properties of the insulating glazing or to monitor at least one physical property of the insulating glazing. The sensor unit has, for this purpose, a computing unit for recording and interpreting data, a communication unit for the wireless exchange of data, and energy supply unit, wherein the forwarding means comprise the communication unit.

The computing unit can include a microcontroller or a central processing unit and a storage medium with nonvolatile memory for storing measured values.

The communication unit can have an electronics unit and an antenna. The communication unit is provided to transmit data on a regular basis. The communication unit can be set up to exchange data via a wireless communication link, in particular for connecting low energy devices (LPWAN, e.g., Bluetooth Low Energy®, wireless LAN, ZigBee® or another IoT radio standard such as Sigfox® or LoRa®), to a terminal or to an external unit (for example, a router, (backend) server, mobile phone antenna). The communication unit includes, in particular, a transmitter for transmitting a high-frequency radio signal, wherein the forwarding means can comprise the external unit.

Data can be queried and sent at different time intervals. For example, information can be sent with a frequency of 6 times a minute up to a frequency of once a year, preferably 3 times a minute up to once a month.

The energy supply unit includes an energy generation unit and an energy store. The energy generation unit can have a unit for thermal energy harvesting, photovoltaic energy generation, or radio, RF, UHF energy harvesting. The energy store preferably has a capacity, particularly preferably a so-called super capacity or a battery, in particular a rechargeable battery. During energy generation, the energy store is recharged. When a predefined threshold value is exceeded, a measurement is performed and the data are either buffered in the sensor system or forwarded directly to a user.

Furthermore, the sensor unit has at least one sensor. The sensor can be a sensor for measuring temperature, pressure, humidity, thermal flow, radiation in the visible range and in the infrared range, and/or for detecting gas. As a result, the properties of the insulating glazing, in particular the insulating properties can be determined.

In one embodiment, the sensor system comprises a first sensor unit and a second sensor unit for measuring data, with the second sensor unit arranged outside the insulating glazing. By way of example, a thermal insulation property can be detected directly by measuring a thermal flow through the insulating glazing. For this, the first sensor unit can be arranged in the glazing unit and the second sensor unit outside the glazing. This is particularly advantageous since only a few resources are required. Alternatively, the first sensor unit can be arranged on the surface (I) of the outer pane facing the exterior space and the second sensor unit can be arranged on the surface (IV) of the inner pane facing the interior space. Alternatively, or additionally, further sensor units can be arranged on the surface (II) of the outer pane and the surface (III) of the inner pane. One of the sensor units can detect weather or thermostatic data of an interior temperature.

Thermal insulation properties of the insulating glazing can be detected directly, for example, by measuring the gas present in the first cavity. Primarily, the presence of the gas is measured (e.g., in ppm) or the partial pressure of the gas is measured. The cavity can be filled with air or a gas, in particular a noble gas such as argon or krypton. Additionally, humidity and/or pressure of the gas can be measured. As a result, increased reliability and accuracy of the measurement can be achieved.

Alternatively, the insulation properties can be determined indirectly by combining the measurement values of multiple sensor units. In a preferred embodiment, the data are detected and combined in a time profile with respect to temperature, humidity, and/or pressure by means of the sensor system.

In some embodiments, the sensor system is intended to forward the data generated to a cloud service, WLAN router, mobile phone antenna, and/or a mobile terminal. For the data exchange, short-range radio links, for example, Bluetooth®, ZigBee®, or wireless LAN, also referred to as Wi-Fi, can, in particular, be used. Particular advantages result when the data determined by the sensor unit(s) are evaluated using data stored in a cloud service. Thus, the data can be read out remotely.

For example, a parameter that indicates the quality of the thermal insulation and/or that is compared with a theoretically calculated initial value or a value of a comparable, known insulating glazing can be calculated in a central database of the Internet or in a software application (app). These parameters can be presented in an easily readable figure, for example, in the form of a star rating, energy class rating, an x/10 rating, or the like for the energy efficiency. This is particularly advantageous when the sensor system includes a particularly large number of sensor units.

The mobile terminal can be, for example, a mobile phone, so-called smartphone or tablet. The mobile terminal has a touch-sensitive screen, on which the data generated, an evaluation of the insulating glazing in energy classes, a time profile of a measurement value, and/or a recommendation for action can be displayed. Thus, a user of the mobile terminal can be informed in a particularly convenient and clear manner about the state of the insulating glazing.

In some embodiments, the mobile terminal receives the data directly from the sensor system that has determined it by means of the sensor unit and evaluated it. Alternatively, the data can be transmitted to the mobile terminal from a remote data store (e.g., a so-called edge service or cloud service).

The sensor system can have a plurality of sensor units arranged in a building, wherein the sensor units are in each case provided to forward the data generated to a mobile phone antenna.

The invention also includes an insulating glazing assembly, comprising an insulating glazing and a sensor system. The insulating glazing has at least a first pane with a first surface (I) and a second surface (II), with the first pane configured as an outer pane. The insulating glazing also has a second pane with a first surface (III) and a second surface (IV), with the second pane configured as an inner pane, and a first cavity that is arranged between the first pane and the second pane and a sensor unit arranged therein.

The sensor system contains at least one sensor unit, wherein the sensor unit is provided for measuring at least one measurement value. The sensor system is provided for transmitting data and for detecting a time profile of the thermal insulation properties of the insulating glazing.

In a preferred embodiment, the sensor system has a second sensor unit outside the cavity on the first surface of the first pane.

Another aspect of the invention includes a computer program product for determining a quality of the thermal insulation of an insulating glazing in a building when the computer program runs on a computer, a processor, or a programmable hardware component. The same advantages and embodiments apply as described in connection with the system according to the invention.

It goes without saying that the features mentioned above and explained in more detail below can be used not only in the combinations and configurations indicated, but also in other combinations and configurations or in isolation without departing from the scope of the present invention.

The invention is explained in detail in the following with reference to figures and exemplary embodiments. The figures are a schematic representation and are not to scale. The figures in no way restrict the invention.

They depict:

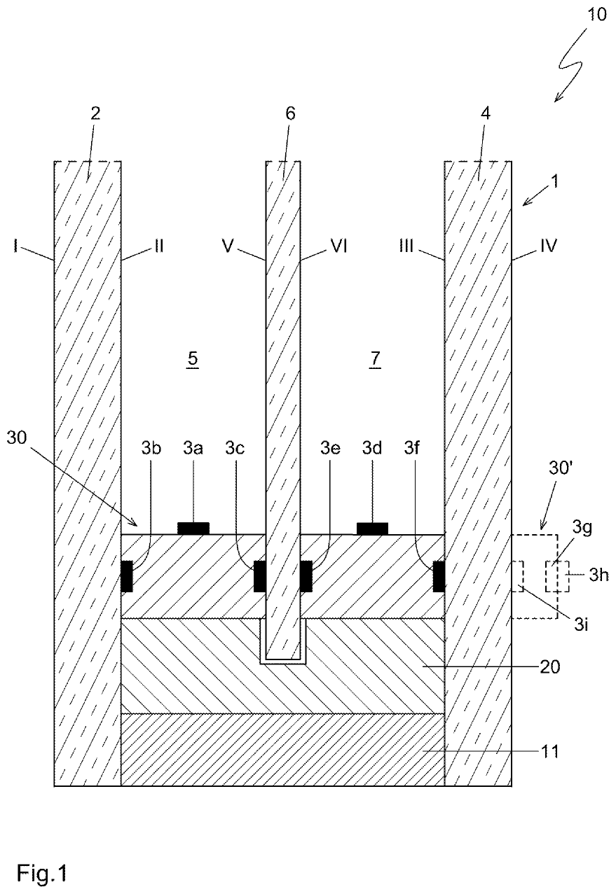

FIG. 1 an embodiment of an insulating glazing assembly according to the invention,

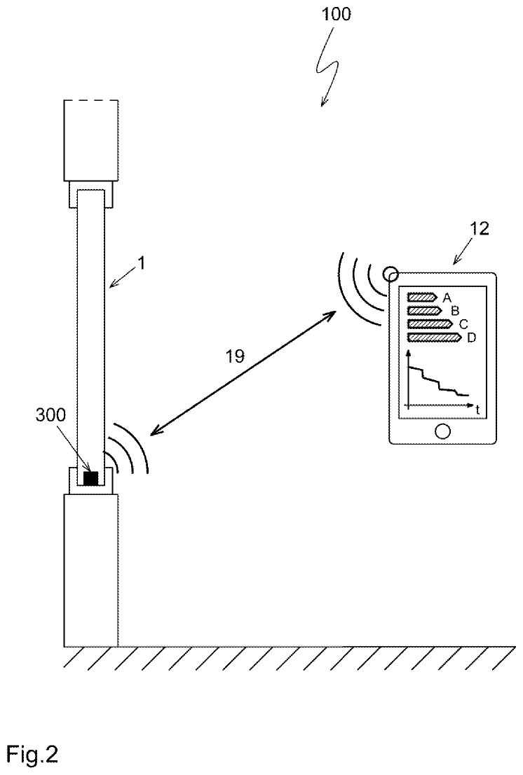

FIG. 2 a first embodiment of a system according to the invention,

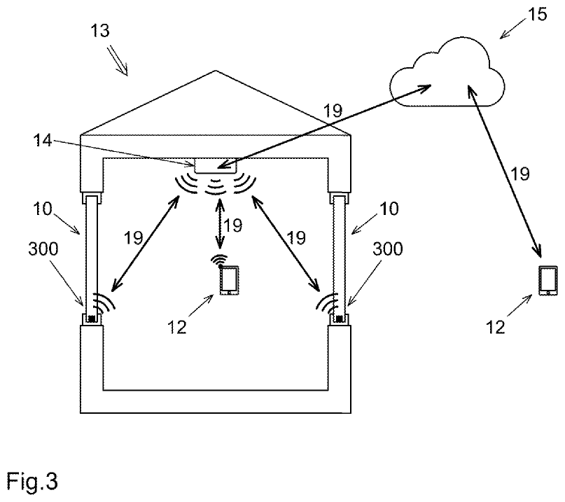

FIG. 3 a second embodiment of a system according to the invention, and

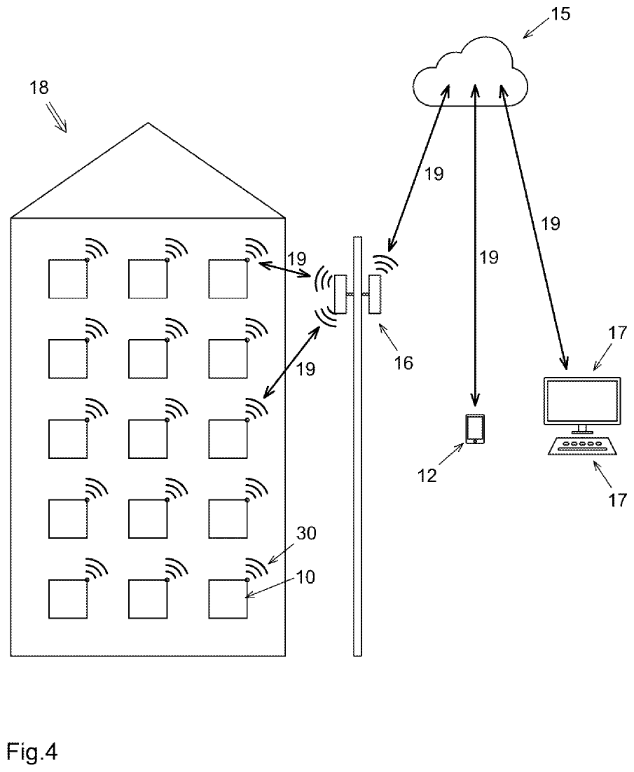

FIG. 4 a third embodiment of a system according to the invention.

Specifications with numerical values are generally not to be understood as exact values, but also include a tolerance from ±1% up to ±10%.

FIG. 1 depicts an embodiment of an insulating glazing assembly 10, in particular an edge region of an insulating glazing 1. The insulating glazing assembly 10 comprises the insulating glazing 1 (IGU) having a first pane 2 with a first surface (I) and a second surface (II), a second pane 4 with a first surface (III) and a second surface (IV), and a third pane 6. The first pane 2 is provided as an outer pane, which, in the installed state, is oriented toward a building exterior. The second pane 4 is provided as an inner pane, which, in the installed state, is oriented toward a building interior.

The first pane 2 and the second pane 4 are spaced apart from one another by a spacer 20.

The second surface (II) of the first pane 2 and a first surface (V) of the third pane 6 form, together with the spacer 20, boundaries of the first cavity 5.

The spacer 20 has a groove that runs parallel to two outer pane contact surfaces of the spacer 20. The groove is provided to accommodate the third pane 6. The third pane 6 is inserted into the groove of the spacer 20. Along with the spacer 20, the third pane 6 and the second pane 4 form a second cavity 7. The first pane 2 and the second pane 4 protrude beyond the spacer 20, creating an outer interpane space that is filled with an external seal 11. The seal 11 can be a silicone seal. The first pane 2 and the second pane 4 are made of soda lime glass with a thickness of with a thickness of 3 mm, while the third pane 6 is formed by soda lime glass with a thickness of 2 mm.

The insulating glazing assembly further includes a sensor system 300 that is provided for transmitting data and for detecting a time profile of the thermal insulation properties of the insulating glazing.

A sensor system 300, in turn, comprises two sensor units 30 and 30′, with each sensor unit 30, 30′ provided for measuring at least one measurement value. The measurement value indicates a physical property, in particular the thermal flow, of the insulating glazing. The sensor unit 30 has a sensor 3a, a computing unit for generating data, an energy supply unit, and a communication unit for the wireless exchange of data. The sensor unit 30 is arranged in the first cavity 5, in particular on the spacer 20. The sensor unit 30 has, for example, a pressure sensor, a gas sensor, or a humidity sensor as sensors 3a to 3i.

The insulating glazing 1 of FIG. 1 is, by way of example, provided with a total of nine sensors 3a to 3i. Of these, the sensors 3b and 3c are applied on the surface (II) of the first pane 2 or on the surface (V) of the third pane 6. The sensor 3b is thermally conductively connected to the first pane 2 (outer pane in the installed state). The sensors 3b and 3f can, for example, be implemented, in each case, as a thermal flow sensor, a temperature sensor, or a light sensor for UV, IR, or VIS. The sensors 3c and 3e can be, for example, a thermal flow sensor or a temperature sensor.

Optionally, additional sensor units 30′ can be mounted in or on the insulating glazing 1. The sensor unit 30′ is arranged outside the insulating glazing on the second pane 4. The sensor unit 30′ can, for example, have the sensor 3g, 3h, or 3i as a temperature sensor. The sensor 3i can be provided for determining the temperature at the surface (IV) of the pane 4, i.e., on the room side of the second pane 4 (inner pane).

This exemplary arrangement serves to illustrate the mounting possibilities of the sensor units 30, 30′ and the sensors 3a to 3i in the case of an insulating glazing unit according to a first embodiment of the invention; in practice, normally only one or two of the possible mounting positions shown here will be occupied.

FIG. 2 depicts a first embodiment of a system 100 according to the invention for determining a quality of the thermal insulation of the insulating glazing 1. The system comprises the insulating glazing 1 having a sensor system 300 and a means for forwarding data generated by the sensor system 300 to a terminal 12 of the system 300. The terminal 12 is implemented as a tablet PC, smartphone, RFID reader, or a special mobile device that has a touch-sensitive screen. During configuration, a pairing procedure between the communication unit of the sensor system 300 and the terminal 12 may be necessary, in particular with data transmission over a short distance by radio technology.

Data can be displayed on the touch-sensitive screen, in particular the quality of the thermal insulation of the insulating glazing 1, an evaluation of the insulating glazing 1 in energy classes, a time profile of a measurement value, and/or a recommendation for action. The terminal 12 is linked via a wireless data connection 19, e.g., RFID or Bluetooth®, for the wireless exchange of data with the sensor system 300. The data generated by the sensor system can be sent at different time intervals. For example, information can be sent at a frequency of 6 times a minute up to the frequency of once a year, preferably 3 times a minute up to once a month.

The sensor unit 300 can additionally have a solar cell that, when illuminated, produces sufficient electrical energy to supply the sensor system with energy for the measuring of the measurement values and transmitting the data.

FIG. 3 depicts a second embodiment of a system 100 according to the invention using the example of a small building, e.g., a single-family house. The possible paths for data transmission are indicated by arrows between the components of the system 100. In this case, the data transmission of the communication unit of the sensor system 300 is forwarded by a local device. In the context of the invention, “local” can mean that the data transmission of the sensor 30 can be sent within the same room to a local device 14, in particular a router, within the same building. In this case, the local device 14 is continuously switched on and waiting for the data transmission of the sensor system 300. The local device 14 can, optionally, be connected to the Internet. If the sensor system has sufficient power to send data, it transmits data to the local device 14. The data can include measurement values or, preferably, already evaluated data regarding a current quality of the insulating glazing 1 based on the measurement values.

If the terminal 12 of a user is connected to the local device 14, the user can receive the latest measurement values either directly or via the Internet.

In another embodiment, provision can be made for the local device 14 to automatically load the data received from the sensor system 300 into a database of a remote data storage device, so-called cloud service 15. The user can then read out the data from the cloud service, e.g., via a website (homepage) or local application software (app).

FIG. 4 depicts another embodiment of a system 100 according to the invention using the example of a building 18. The building 18 is substantially larger than the building 13 of FIG. 3. The building 18 is, for example, a hospital, office building, or hotel building.

The possible paths for data transmission are again indicated by arrows between the components of the system 100. In the event that the user of the system is not in the vicinity of the building such that no short-range connection is possible, the transmission can also take place via a data connection 19 of a mobile network. In this case, the data transmission is forwarded by an antenna 16 of the mobile phone network (5G). The antenna 16 receives the data generated by the sensor system 300. A local device inside a room or building for forwarding the data generated by the sensor system 300 is not required in this example.

For this purpose, the data are stored in the cloud service 15. The cloud service 15 can be provided to evaluate the data. The user receives the data on his mobile terminal 17 or another device 17 connected to the cloud service 15 (e.g., PC, notebook, laptop). The user can access the data of the cloud service 15 by means of application software (app) installed thereon or a home page. In this embodiment, a low frequency for transmitting the data can be selected, in particular, the frequency can be lower than the frequency in the embodiments of FIGS. 2 and 3. Thus, it is possible for the data to be transmitted directly from the communication unit of the sensor system 300 into the remote data storage device 15. The quality of the insulating glazing can be retrieved on the mobile terminal 12 or stationary terminal 17 by means of the app installed thereon. As a result, the user can read out the quality of an insulating glazing from any location by means of his terminal 12 or device 17.

In the embodiments of FIG. 1 through 4, the physical properties and/or the thermal insulation properties of the insulating glazing are recorded for the user of the system in order to determine a quality of the insulating glazing. The service offered to the user or potential customer can, however, be extended to include advice on an IGU replacement, installer service, thermal insulation warranty, thermal insulation leasing.

In the case of advice for replacement of an insulating glazing (IGU), the user would additionally receive advice about potential future insulating glazing units, taking into account the climate and weather data for the geographical location of the IGU, costs, and CO2 footprint of the replacement compared to the cost and CO2 footprint (e.g., for heating) of the current IGU. As a result, when replacing the IGU, the user receives a clear recommendation, in addition to an estimate of the ecological and economical effect. Payment for this service could be annual, per use, or once for the service life of the IGU.

Additionally, in the case of a recommendation to replace the IGU, contact data of an installer could be displayed directly as additional information on the user's screen. This also minimizes the time required here with regard to the overall effort involved in replacing the insulating glazing.

Moreover, an offer for a warranty extension can be made to the user based on the measurement values detected.

Provision is also made for the user, when determining a quality of the thermal insulation of the insulating glazing, to also be informed about a purchase, rental, or leasing offer. As a result, further advantages can be achieved by the user being advised in detail concerning the insulating glazing. Since the interest of the user himself is usually the greatest at this time, it is precisely then that information tailored to his needs is quite useful. Thus, the user can also make an appropriate decision with regard to his financial needs at the relevant time and receives the relevant information for his decision-making.

### LIST OF REFERENCE CHARACTERS

1 insulating glazing
2 first pane
3a-3i sensor
4 second pane
5 first cavity
6 third pane
7 second cavity
8 insulating glazing assembly
11 seal
12 terminal
13 single-family house
14 local device (router)
15 remote data storage (cloud service)
16 antenna of a mobile phone network
17 a terminal connected to a cloud service
18 building
19 data connection
20 spacer
30, 30′ sensor unit
300 sensor system
100 system
I exterior-side surface of the first pane 2
II interior-side surface of the first pane 2
III exterior-side surface of the second pane 4
Iv interior-side surface of the second pane 4
V exterior-side surface of the third pane 6
VI interior-side surface of the third pane 6

1. A system for determining a quality of a thermal insulation of an insulating glazing in a building having an insulating glazing, the system comprising:
a sensor system having at least one sensor unit, wherein the at least one sensor unit is provided for measuring at least one measurement value and the sensor system is provided for detecting a time profile of thermal insulation properties of the insulating glazing, and
means for forwarding data generated by the sensor system to a terminal, wherein
the sensor unit has a computing unit for generating data, a communication unit for the wireless exchange of data, and an energy supply unit; and the at least one measurement value indicates a physical property of the insulating glazing.

2. The system according to claim 1, wherein the sensor system is provided for monitoring at least one physical property of the insulating glazing and generating data based on measurement values detected by the sensor unit.

3. The system according to claim 2, wherein the sensor unit has at least one sensor for detecting a time profile of the thermal insulation properties of the insulating glazing and/or for monitoring at least one physical property of the insulating glazing.

4. The system according to claim 4, wherein the sensor is a sensor for measuring temperature, pressure, humidity, thermal flow, radiation in the visible range and/or in the infrared range, and/or for detecting gas.

5. The system according to claim 1, wherein the sensor system comprises a first sensor unit and a second sensor unit, wherein the second sensor unit is arranged outside the insulating glazing.

6. The system according to claim 1, wherein a first sensor unit is arranged on the surface of an outer pane of the insulating glazing facing the exterior space and the second sensor unit is arranged on the surface of the inner pane facing the interior space.

7. The system according to claim 1, wherein the sensor system is adapted to forward the data generated to a remote data storage device, a local device, a mobile phone antenna, and/or a mobile terminal.

8. The system according to claim 1, wherein the mobile terminal is a mobile phone, smartphone, or tablet.

9. The system according to claim 7, wherein the terminal has a touch-sensitive screen to display the data generated.

10. The system according to claim 1, wherein the sensor system has a plurality of sensor units arranged in a building, wherein the plurality of sensor units are in each case provided to forward the data generated to a mobile phone antenna outside the building.

11. The system according to claim 1, wherein the insulating glazing comprises:
a first pane with a first surface and a second surface, wherein the first pane is configured as an outer pane,
a second pane with a first surface and a second surface, wherein the second pane is configured as an inner pane,
a first cavity, which is arranged between the first pane and the second pane.

12. The system according to claim 11, wherein the insulating glazing includes a third pane with a first surface and a second surface, wherein the third pane is arranged between the first pane and the second pane, wherein the first cavity is arranged between the first pane and the third pane.

13. An insulating glazing assembly, comprising:
an insulating glazing comprising a first pane with a first surface and a second surface, wherein the first pane is configured as an outer pane, a second pane with a first surface and a second surface, wherein the second pane is configured as an inner pane, a first cavity, which is arranged between the first pane and the second pane,
a sensor system having at least one sensor unit, wherein the sensor unit is provided for measuring at least one measurement value, and
a first sensor unit arranged in the first cavity,
wherein the sensor system is provided for transmitting data via a mobile phone network and for detecting a time profile of the thermal insulation properties of the insulating glazing based on the measurement value.

14. The insulating glazing assembly according to claim 13, comprising a second sensor unit arranged outside the cavity on the first surface of the first pane.

15. A non-transitory computer program product, suitable for determining a quality of the thermal insulation of an insulating glazing in a building.

16. The system according to claim 1, wherein the physical property is a thermal flow.

17. The system according to claim 9, wherein the data generated comprise a quality of the thermal insulation of the insulating glazing, an evaluation of the insulating glazing in energy classes, a time profile of a measurement value, and/or a recommendation for action.
